(19) United States
(12) Patent Application Publication
(10) Pub. No.: US 2022/0347876 A1
(43) Pub. Date: Nov. 3, 2022

(54) METALS FOR RAZOR BLADE APPLICATIONS

(71) Applicant: The Gillette Company LLC, Boston, MA (US)

(72) Inventor: Ming Laura Xu, Natick, MA (US)

(21) Appl. No.: 17/306,685

(22) Filed: May 3, 2021

(51) Int. Cl. B26B 21/60; B05D 1/02

(52) U.S. Cl. CPC B26B 21/60; B05D 1/02; B05D 2506/15; B05D 2202/15; B05D 2202/45

(57) ABSTRACT

Razor blades with two or more materials and/or methods of fabricating the same. In one example, a bimetal razor blade can comprise a blade body and a blade edge. The blade body can have a length and a width. The blade body can be formed of a first substrate portion comprising a first material having a first hardness. The blade edge can extend along the length. The blade edge can be formed of a second substrate portion coupled to the first substrate portion. The second substrate portion can comprise a second material having a second hardness that is distinct from the first hardness. The first and second materials can be metals.

### FIELD OF THE INVENTION

The subject disclosure relates to razors, and more specifically, to bimetal razor blades and methods of fabricating the same.

### BACKGROUND OF THE INVENTION

Razor blades can made from a special type of martensitic stainless steel. Some notable aspects of martensitic stainless steel can include excellent hardenability and/or very fine microstructure for sharp edge formation. Martensitic stainless steel can typically be hardened to 750 Hv hardness or above quickly. One aspect of martensitic stainless steel that facilitates such high hardenability is its well spheroidized, uniformly distributed, and high-density secondary carbides. Such aspects of martensitic stainless steel can be advantageous in razor blade applications. However, high temperature conditions involved in heat treatment processes (e.g., >1000° C.) can limit impede application of some surface technologies to razor blades fabricated using materials such as martensitic stainless steel. For instance, polymer coatings for various functions and decorations can generally not withstand such high temperature conditions.

During a heat treatment process, an entire substrate strip used to fabricate razor blades can be hardened even though high hardness can generally only be advantageous portions of the substrate strip that form a blade edge. In some cases, high blade body hardness can be less than desirable. For example, high hardness for portions of the substrate strip that form a blade body can negatively impact razor blade flexibility and/or bendability. Moreover, high-temperature heat treatment processes can result in blade steel strip distortion and/or affect the quality of the downstream fabrication processes. Also, heat treatment processes implemented for razor blade fabrication can involve lots of resources, energy consumption and huge space of manufacturing facility.

### SUMMARY OF THE INVENTION

The following presents a summary to provide a basic understanding of one or more embodiments of the invention. This summary is not intended to identify key or critical elements or delineate any scope of the particular embodiments, or any scope of the claims. Its sole purpose is to present concepts in a simplified form as a prelude to the more detailed description that is presented later. In one or more embodiments described herein, bimetal razor blades and methods of fabricating the same are described.

According to an embodiment, a bimetal razor blade can comprise a blade body and a blade edge. The blade body can have a length and a width. The blade body can be formed of a first substrate portion comprising a first material having a first hardness. The blade edge can extend along the length. The blade edge can be formed of a second substrate portion coupled to the first substrate portion. The second substrate portion can comprise a second material having a second hardness that is distinct from the first hardness.

According to another embodiment, a bimetal razor blade can comprise a blade body, a first blade edge, and a second blade edge. The blade body can have a length and a width. The blade body can be formed by a first substrate portion comprising a first material having a first hardness. The first blade edge can extend along the length. The first blade edge can be formed by a second substrate portion coupled to the first substrate portion. The second substrate portion can comprise a second material having a second hardness that is distinct from the first hardness. The second blade edge can extend along the length and laterally oppose the first blade edge. The second blade edge can be formed by a third substrate portion coupled to the first substrate portion.

According to another embodiment, a method can comprise providing an elongated strip of substrate comprising a first substrate portion coupled in parallel to a second substrate portion. The first substrate portion can comprise a first material with a first hardness and the second substrate portion can comprise a second material with a second hardness that is distinct from the first hardness. The method can further comprise sharpening the second substrate portion to form a cutting-edge structure with a blade tip and a plurality of bevels that diverge from the blade tip. The method can further comprise cutting a lengthwise extending portion of the substrate strip perpendicular to a longitudinal direction to singularize a bimetal razor blade with a blade body formed by the first substrate portion and a blade edge comprising the cutting-edge structure.

### BRIEF DESCRIPTION OF THE DRAWINGS

FIG. 1 illustrates an example, non-limiting isometric view depicting a traverse wound coil comprising a substrate strip, in accordance with one or more embodiments described herein.

FIG. 2 illustrates an example, non-limiting isometric view depicting the traverse wound coil of FIG. 1 following a perforation process, in accordance with one or more embodiments described herein.

FIG. 3 illustrates an example, non-limiting close-up view depicting the substrate strip of the traverse wound coil of FIG. 2 following a sharpening process, in accordance with one or more embodiments described herein.

FIG. 4 illustrates an example, non-limiting double-edge razor blade, in accordance with one or more embodiments described herein.

FIG. 5 illustrates an example, non-limiting isometric view depicting a bimetal substrate strip, in accordance with one or more embodiments described herein.

FIG. 6 illustrates an example, non-limiting isometric view depicting a bimetal razor blade fabricated using the bimetal substrate strip of FIG. 5, in accordance with one or more embodiments described herein.

FIG. 7 illustrates an example, non-limiting isometric view depicting the bimetal substrate strip of FIG. 5 in an intermediate fabrication state associated with a sharpening process, in accordance with one or more embodiments described herein.

FIG. 8 illustrates an example, non-limiting isometric view depicting a multi-metal substrate strip, in accordance with one or more embodiments described herein.

FIGS. 9A-9C illustrate example, non-limiting cross-sectional views of various lateral edge geometries of bimetal substrate strips prior to a sharpening process, in accordance with one or more embodiments described herein.

FIG. 10 illustrates an example, non-limiting cross-sectional view of a razor blade unit, in accordance with one or more embodiments described herein.

FIG. 11 illustrates an example, non-limiting cross-sectional view of another razor blade unit, in accordance with one or more embodiments described herein.

FIG. 12 illustrates a flow diagram of an example, non-limiting method of fabricating bimetal razor blades, in accordance with one or more embodiments described herein.

### DETAILED DESCRIPTION OF THE INVENTION

### Examples/Combinations

A. A razor blade comprising:
a) a blade body having a length and a width, the blade body formed of a first substrate portion comprising a first material having a first hardness; and
b) a blade edge extending along the length, the blade edge formed of a second substrate portion coupled to the first substrate portion, the second substrate portion comprising a second material having a second hardness that is distinct from the first hardness.
   B. The razor blade according to paragraph A, wherein the first hardness is less than the second hardness.
   C. The razor blade according to paragraph A or B, wherein the first hardness ranges from about 150 Vickers hardness to about 650 Vickers hardness.
   D. The razor blade according to paragraphs A-C, wherein the second hardness ranges from about 600 Vickers hardness to about 850 Vickers hardness.
   E. The razor blade according to paragraphs A-D, wherein the first substrate portion and the second substrate portion form a bimetal structure.
   F. The razor blade according to paragraphs A-E, wherein the first material comprises a first metal and the second material comprises a second metal that is distinct from the first metal.
   G. The razor blade according to paragraphs A-F, wherein the first material comprises stainless steel, a copper alloy, hygienic steel, colored steel, or a combination thereof.
   H. The razor blade according to paragraphs A-G, wherein the first substrate portion comprises copper, silver, or a combination thereof.
   I. The razor blade according to paragraphs A-H, wherein the second material comprises hardened stainless steel, hardened tool steel, ceramic material, or a combination thereof.
   J. The razor blade according to paragraphs A-I, wherein the second substrate portion is coupled to the first substrate portion via an interface that is non-orthogonal to a surface of the blade body that extends between the length and the width.
   K. The razor blade according to paragraphs A-J, wherein the second substrate portion is coupled to the first substrate portion via cladding, additive manufacturing, laser-assisted deposition, plasma-assisted deposition, thermal spray, or a combination thereof.
   L. The razor blade according to paragraphs A-K, wherein the blade edge comprises a cutting-edge structure formed of the second substrate portion, and wherein the cutting-edge structure comprises a blade tip and a bevel that diverges from the blade tip.
   M. The razor blade according to paragraph L, wherein a coating is disposed on the bevel.
   N. The razor blade according to paragraphs A-M, wherein a lateral edge of the second substrate portion forming the blade edge relative is non-linear prior to formation of a cutting-edge structure.
   O. The razor blade according to paragraphs A-N, wherein the first substrate portion or the second substrate portion have a thickness of less than 100 micrometers.
   P. A razor blade comprising:
a) a blade body having a length and a width, the blade body formed by a first substrate portion comprising a first material having a first hardness; and
b) a first blade edge extending along the length, the first blade edge formed by a second substrate portion coupled to the first substrate portion, the second substrate portion comprising a second material having a second hardness that is distinct from the first hardness; and
c) a second blade edge extending along the length and laterally opposing the first blade edge, the second blade edge formed by a third substrate portion coupled to the first substrate portion.
   Q. The razor blade according to paragraph P, wherein the third substrate portion comprises a third material having a third hardness that is distinct from the first hardness.
   R. The razor blade according to paragraph P or Q, wherein the third substrate portion comprises a third material having a third hardness that is distinct from the second hardness.
   S. The razor blade according to paragraphs P-R, wherein the first substrate portion, the second substrate portion, and the third substrate portion form a bimetal structure.

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Razor blades can generally be fabricated or formed using a substrate material such as stainless-steel. One type of stainless-steel that can facilitate fabricating razor blades with thinner and/or stronger blade edges than other substrate materials is martensitic stainless-steel. In particular, martensitic stainless-steel comprises well spheriodized, uniformly distributed, and/or high-density secondary carbides that can facilitate obtaining higher hardness values (e.g., a hardness value of about 750 Vickers hardness or higher) that can be obtained by other varieties of stainless-steel and/or other substrate materials. Obtaining such hardness values generally involves providing a traverse wound coil 100 with a substrate strip 110 comprising a substrate material such as stainless-steel.

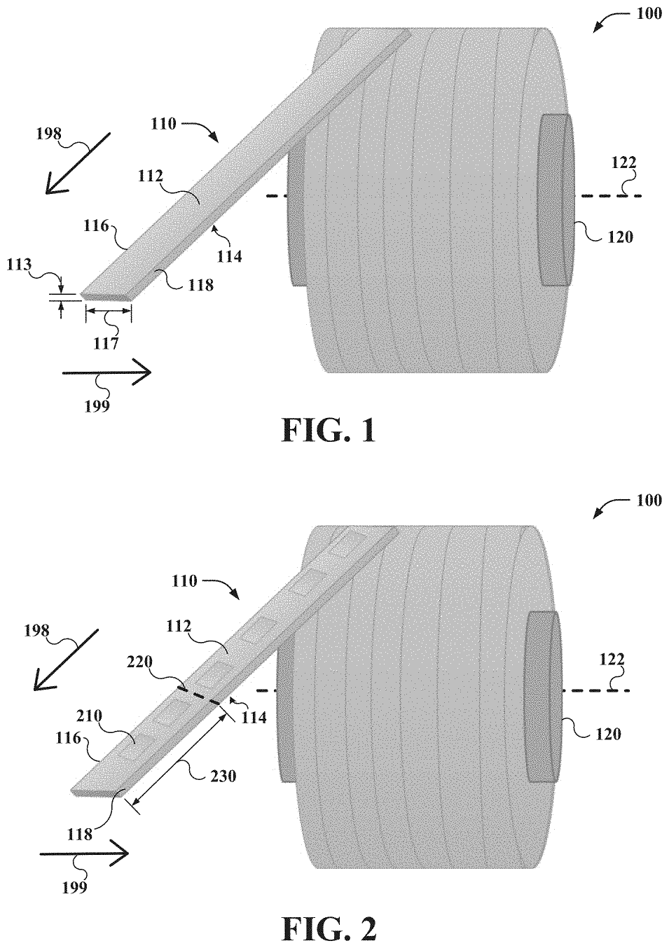

As shown by FIG. 1, traverse wound coil 100 can be formed by winding substrate strip 110 upon a spool 120. Substrate strip 110 can have opposing longitudinal surfaces (e.g., longitudinal surfaces 112 and/or 114) that extend in a longitudinal direction 198 to define a thickness 113 of substrate strip 110. In an embodiment, thickness 113 can substantially coincide with a corresponding thickness of a razor blade fabricated using substrate strip 110. Substrate strip 110 can also have a pair of lateral edges (e.g., lateral edges 116 and/or 118) opposing in a lateral direction 199 to define a width 117 of substrate strip 110. As shown by FIG. 2, a perforation process can introduce one or more notches 210 between the pair of lateral edges (e.g., lateral edges 116 and/or 118) of substrate strip 110. The one or more notches 210 can be dimensioned to receive transport fingers (e.g., cogs and/or teeth) of a manufacture apparatus to facilitate rotation of spool 120 about rotation axis 122. Rotation of spool 120 about rotation axis 122 can advance substrate strip 110 in the longitudinal direction 198 for further processing.

Such further processing can include performing a heat treatment process on substrate strip 110 using a heat treatment furnace that can be inline with the longitudinal direction 198. The heat treatment process performed on substrate strip 110 can include: an austenitization process; a quenching process; a deep quenching process; and/or a precipitation hardening process. The heat treatment process can involve the heat treatment furnace subjecting portions of substrate strip 110 passing through the heat treatment furnace to temperatures of about 1000 degrees Celsius (° C.) or greater. Subjecting substrate strip 110 to such temperatures can increase a hardness value of the substrate material comprising substrate strip 110. For example, the heat treatment process can increase the hardness value of the substrate material comprising substrate strip 110 to about 750 Vickers hardness or higher. As another example, the heat treatment process can increase the hardness value of the substrate material comprising substrate strip 110 to about 650 Vickers hardness to facilitate a sharpening of substrate strip 110. As another example, the heat treatment process can increase the hardness value of the substrate material comprising substrate strip 110 to about 620 Vickers hardness that can correspond to a minimal hardness value for substrate strip 110 to facilitate shaving operations. In some embodiments, the heat treatment process can increase the hardness value of the substrate material comprising substrate strip 110 to any suitable hardness having characteristics such as forming martensites during the heat treatment process or forming a high density of secondary carbides that can promote a harder martensitic phase and/or higher hardness values. In an embodiment in which the substrate material comprising substrate strip 110 is stainless-steel, the heat treatment process can initiate martensitic transformation of the stainless-steel. In an embodiment, the substrate material comprising substrate strip 110 can include, but not be limited to, ferrous alloys, such as carbon steels, low-allow steels, tool steels, and/or various types of stainless steel.

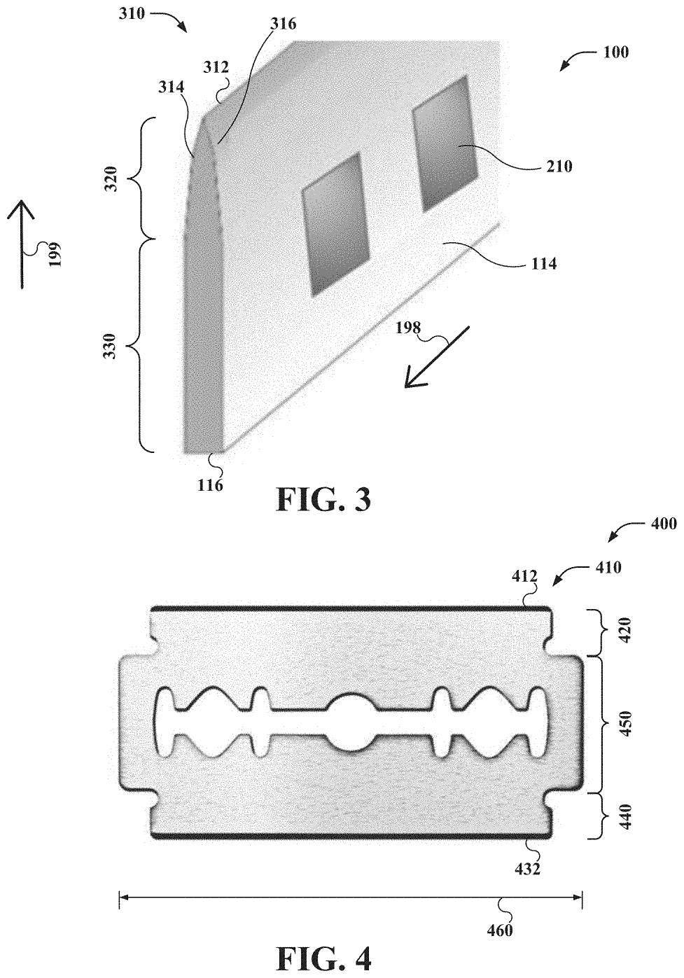

Further processing of substrate strip 110 can also include performing a sharpening process on one or more lateral edge (e.g., lateral edges 116 and/or 118) of substrate strip 110. As best seen in FIG. 3, the sharpening process can involve forming a cutting-edge structure 310 in a portion 320 of substrate strip 110 that forms a blade edge of razor blades fabricated using substrate strip 110. Cutting-edge structure 310 can comprise a blade tip 312 and one or more bevels (e.g., bevels 314 and/or 316) that diverge from blade tip 312. In FIG. 3, blade tip 312 can substantially coincide with lateral edge 118 prior to formation of cutting-edge structure 310. While FIG. 3 depicts substrate strip 110 as comprising one portion (e.g., portion 320) for forming a blade edge, one skilled in the art will appreciate that substrate strip 110 can comprise a portion for forming an additional blade edge when fabricating a double-edge razor blade.

FIG. 4 illustrates an example, non-limiting double-edge razor blade 400, in accordance with one or more embodiments described herein. As shown by FIG. 4, double-edge razor blade 400 can have a pair of blade edges (e.g., blade edges 420 and/or 440) extending in parallel along a length 460 of double-edge razor blade 400 on opposing sides of a blade body 450. In this example, fabricating double-edge razor blade 400 can involve performing a sharpening process to form a cutting-edge structure 410 with a blade tip 412 in blade edge 420 and a cutting-edge structure 430 with a blade tip 432 in blade edge 440. In an embodiment and with reference to FIG. 3, one blade edge (e.g., blade edge 420) of the pair of blade edges comprising double-edge razor blade 400 can be implemented using portion 320 of substrate strip 110. In this embodiment, the other blade edge (e.g., blade edge 440) of the pair of blade edges comprising double-edge razor blade 400 can be implement using another portion of substrate strip 110.

In an embodiment, that other portion of substrate strip 110 for implementing that other blade edge of double-edge razor blade 400 can comprise a subset of a portion 330 of substrate strip 110 that forms a blade body of razor blades fabricated using substrate strip 110. In this embodiment and if blade edge 440 corresponds to that other blade edge of double-edge razor blade 400, blade tip 432 can substantially coincide with lateral edge 116 of substrate strip 110 prior to formation of cutting-edge structure 430. In an embodiment, that other portion of substrate strip 110 for implementing that other blade edge of double-edge razor blade 400 can comprise an additional substrate portion (not shown) coupled to portion 330 of substrate strip 110 via lateral edge 116. In this embodiment and if blade edge 440 corresponds to that other blade edge of double-edge razor blade 400, blade tip 432 can substantially coincide with a lateral edge of the additional substrate portion that extends in parallel with lateral edge 116 of substrate strip 110 prior to formation of cutting-edge structure 430.

Further processing of substrate strip 110 can also include a coating process in which one or more coatings can be applied to substrate strip 110. The coating process can comprise application of a strengthening coating to substrate strip 110. The strengthening coating can include one or more layers of: metal (e.g., chromium, platinum, and/or other metals that can include metal compounds, such as Titanium Nitride, Titanium Carbon Nitride, Titanium Aluminum Nitride, and/or tungsten carbide); carbon material (e.g., diamond-like carbon and/or other carbon-based materials); and/or other strengthening coatings including, but not limited to metal compounds, such as Titanium Nitride, Titanium Carbon Nitride, Titanium Aluminum Nitride, and/or tungsten carbide. In an embodiment, the strengthening coating can be applied to a portion (e.g., portion 320) of substrate strip 110 for forming a blade edge. In an embodiment, the strengthening coating can be applied to substrate strip 110 by sputtering. The coating process can also comprise application of a polymer and/or telomere coating to substrate strip 110. The polymer and/or telomere coating can include one or more layers of: polytetrafluoroethylene (PTFE) and/or other polymer coatings. In an embodiment, the polymer and/or telomere coating can be applied to a portion (e.g., portion 320) of substrate strip 110 for forming a blade edge. In an embodiment, the polymer and/or telomere coating can be applied to substrate strip 110 by spraying. Further processing of substrate strip 110 can also include performing a cutting process to singularize razor blades from substrate strip 110. For example and with reference to FIG. 2, the cutting process can involve cutting substrate strip 110 perpendicular to the longitudinal direction 198 along line 220 to obtain a razor blade of length 230.

Of note, an entirety of substrate strip 110 passing through the heat treatment furnace during the heat treatment process discussed above can be hardened even though increased hardness values are generally only desired for portions of substrate strip 110. For example, increased hardness values can generally be desired for portions (e.g., portion 320) of substrate strip 110 that implement a blade edge of razor blades fabricated using substrate strip 110. In some instances, increased hardness values can be less than desirable for other portions of substrate strip 110. For example, increased hardness values can be less than desirable for portions (e.g., portion 330) of substrate strip 110 that implement a blade body of razor blades fabricated using substrate strip 110. Flexibility and/or bendability can be desirable properties for the blade body of such razor blades to facilitate bent blade applications and/or contour fitting for shaving applications. While desirable for the blade body, increasing hardness values of the portions of substrate strip 110 that implement the blade body can impact or limit flexibility and/or bendability.

The heat treatment process can also impact aspects of razor blade fabrication processes. For example, subjecting substrate strip 110 to temperatures of about 1000° C. or greater can distort (e.g., twist, bend, and/or other distortions, such as strip waviness in a longitudinal direction (e.g., length) and/or traverse (e.g., width) direction) substrate strip 110 such that downstream fabrication processes (e.g., a sharpening process, a coating process, and/or a cutting process) receive substrate strip 110 in a position and/or orientation that deviates from an expected position and/or orientation. Receiving substrate strip 110 in the position and/or orientation that deviates from the expected position and/or orientation can impact fabrication processes downstream of the heat treatment process and/or the quality of blade edges obtained from such processes.

As another example, the heat treatment process subjecting substrate strip 110 to such temperatures can be costly in terms of time, energy consumption, expended resources, manufacturing facility space occupied by heat treatment-related components (e.g., a heat treatment furnace), and/or other costs. Such costs can be avoided or reduced by using a substrate strip comprising substrate material with a hardness value that is sufficient for implementing a blade edge without the substrate strip to a heat treatment process. Also, subjecting substrate strip 110 to temperatures of 1000° C. or greater can prohibit application of various surface technologies that otherwise could be applied to razor blades. For example, some polymer coatings that could be applied to razor blades for aesthetic and/or functional purposes cannot withstand the high temperatures that generally accompany the heat treatment process.

Various embodiments described herein can mitigate the challenges and/or application limitations discussed above with respect to using heat treatment processes to increase hardness values of substrate material. To that end, various embodiments described herein can utilize substrates comprising multiple substrate materials with distinct hardness values to fabricate razor blades, knives, surgical instruments, and/or other objects with blade edges. Such substrates can comprise bimetal substrates, trimetal substrates, tetrametal substrates, and/or other multi-metal substrates. Unlike alloys and/or other admixtures of metal formed by mixing two or more metals, multi-metal substrates described herein (e.g., bimetal substrates) can be formed by multiple substrate materials that can remain distinct while being coupled or joined together.

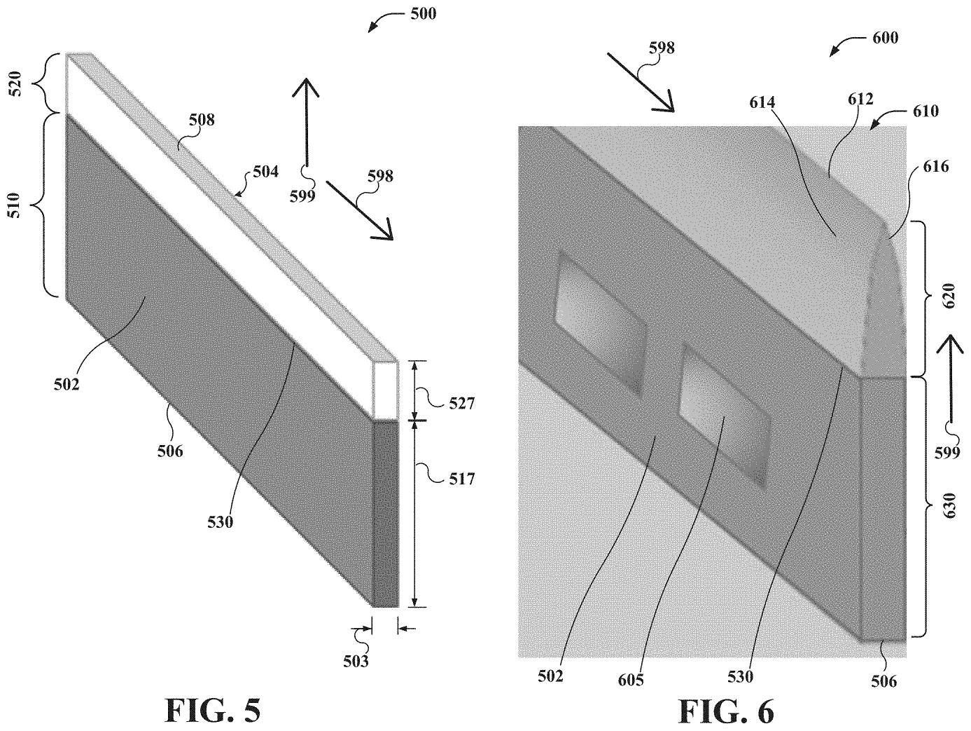

FIG. 5 illustrates an example, non-limiting isometric view depicting a bimetal substrate strip 500, in accordance with one or more embodiments described herein. Bimetal substrate strip 500 can have opposing longitudinal surfaces (e.g., longitudinal surfaces 502 and/or 504) that extend in a longitudinal direction 598 to define a thickness 503 of bimetal substrate strip 500. In an embodiment, thickness 503 can substantially coincide with a corresponding thickness of a bimetal razor blade fabricated using bimetal substrate strip 500. In an embodiment, first substrate portion 510 and/or second substrate portion 520 can have a thickness 503 of less than 100 micrometers. In an embodiment, first substrate portion 510 and/or second substrate portion 520 can have a thickness 503 of between 20 micrometers and 100 micrometers.

Bimetal substrate strip 500 can also have a pair of lateral edges (e.g., lateral edges 506 and/or 508) opposing in a lateral direction 599. As shown by FIG. 5, lateral edge 506 can correspond with a first substrate portion 510 of bimetal substrate strip 500 and lateral edge 508 can correspond with a second substrate portion 520 of bimetal substrate strip 500. First substrate portion 510 can comprise a first width 517 extending in the lateral direction 599 from lateral edge 506. Second substrate portion 520 can comprise a second width 527 extending in the lateral direction 599 from an interface 530 that can couple first substrate portion 510 to second substrate portion 520. Collectively, first width 517 and second width 527 can define a width of bimetal substrate strip 500. In an embodiment, first width 517 can be approximately less than 25 millimeters (mm). In an embodiment, first width 517 can be approximately between 3 mm and 25 mm. In an embodiment, second width 527 can be approximately less than 500 micrometers (μm). In an embodiment, second width 527 can be approximately between 100 μm and 500 μm. In an embodiment, second substrate portion 520 can be coupled to first substrate portion 510 via cladding, additive manufacturing, laser-assisted deposition, plasma-assisted deposition, thermal spray, or a combination thereof. In an embodiment, first substrate portion 510 can comprise copper, silver, an engineering metal and/or alloy, or a combination thereof.

First substrate portion 510 can comprise a first material and second substrate portion 520 can comprise a second material. In an embodiment, the first material of first substrate portion 510 can comprise stainless steel, a copper alloy, hygienic steel, colored steel, coated steel or a combination thereof. In an embodiment, the coated steel can comprise a coating (e.g., a metal coating, a composite material coating, and/or a polymer coating) with one or more additives that deliver one or more additional functionalities (e.g., antimicrobial functionalities, hydrophobic functionalities, hydrophilic functionalities, or other functionalities). In an embodiment, the second material of second substrate portion 520 can comprise hardened stainless steel, hardened tool steel, ceramic material, an engineering metal and/or alloy, or a combination thereof. In an embodiment, the first material of first substrate portion 510 can comprise a first metal and the second material of second substrate portion 520 can comprise a second metal that is distinct from the first metal.

In an embodiment, second substrate portion 520 can comprise a carbide density of approximately 400 particles per 100 square micrometers (μm²). In an embodiment, second substrate portion 520 can comprise a carbide density of less than 1000 particles per 100 μm². In an embodiment, second substrate portion 520 can comprise a carbide density of between approximately 150 particles per 100 μm² and approximately 500 particles per 100 μm². In an embodiment, second substrate portion 520 can comprise a secondary carbide density of less than 120 carbide particles per 100 μm². In an embodiment, second substrate portion 520 can comprise a secondary carbide density of between approximately 80 carbide particles per 100 μm² and approximately 120 carbide particles per 100 μm².

The second material of second substrate portion 520 can have one or more mechanical properties that are different or distinct from corresponding mechanical properties of the first material of first substrate portion 510. One such mechanical property that can distinguish the first material of first substrate portion 510 from the second material of second substrate portion 520 is hardness. In particular, the first material of first substrate portion 510 can have a first hardness and the second material of second substrate portion 520 can have a second hardness that is distinct from the first hardness. In an embodiment, the first hardness of the first material comprising first substrate portion 510 can be less than the second hardness of the second material comprising second substrate portion 520. In an embodiment, the first hardness of the first material comprising first substrate portion 510 can range from about 150 Vickers hardness to about 500 Vickers hardness. In an embodiment, the second hardness of the second material comprising second substrate portion 520 can range from about 600 Vickers hardness to about 850 Vickers hardness.

FIG. 6 illustrates an example, non-limiting isometric view depicting a bimetal razor blade 600 fabricated using bimetal substrate strip 500, in accordance with one or more embodiments described herein. In an embodiment, bimetal razor blade 600 can be utilized for both wet and dry shaving purposes. In an embodiment, bimetal razor blade 600 can be utilized for an electric shaver. Bimetal razor blade 600 can generally be fabricated or formed using bimetal substrate strip 500 in a substantially similar manner as discussed above for razor blades using substrate strip 110 with, at least, one notable exception. Unlike fabricating razor blades using substrate strip 110, bimetal razor blade 600 can be fabricated without performing a heat treatment process on bimetal substrate strip 500. Instead, fabricating bimetal razor blade 600 can involve performing a perforation process to introduce one or more notches 605 between the pair of lateral edges (e.g., lateral edges 506 and/or 508) of bimetal substrate strip 500. The one or more notches 605 can be dimensioned to receive transport fingers (e.g., cogs and/or teeth) of an apparatus that fabricates razor blades to facilitate advancing bimetal substrate strip 500 in the longitudinal direction 598 for further processing. In an embodiment, bimetal substrate strip 500 can be wound upon a spool (e.g., spool 120 of FIGS. 1-2) to form a traverse wound coil.

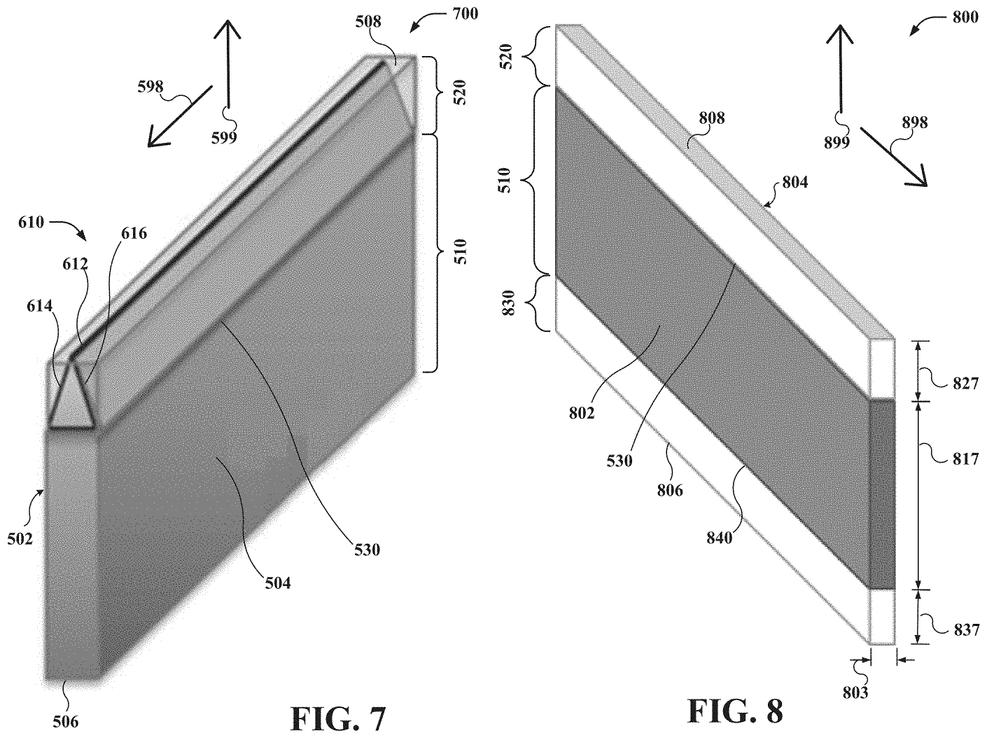

As discussed above, such further processing of bimetal substrate strip 500 does not include performing a heat treatment process. Such further processing of bimetal substrate strip 500 can include performing a sharpening process on the lateral edge 508 of bimetal substrate strip 500 provided by second substrate portion 520. With reference to FIG. 7, the sharpening process can involve forming a cutting-edge structure 610 in second substrate portion 520 of bimetal substrate strip 500 to form a blade edge 620 of bimetal razor blade 600. Cutting-edge structure 610 can comprise a blade tip 612 and one or more bevels (e.g., bevels 614 and/or 616) that diverge from blade tip 612. As best seen in the intermediate fabrication state 700 depicted by FIG. 7, blade tip 612 can substantially coincide with lateral edge 508 prior to formation of cutting-edge structure 610.

One aspect of not subjecting bimetal substrate strip 500 to a heat treatment process can involve fabricating bimetal razor blades using a bimetal substrate strip 500 that can improve shaving performance. For example, while desirable for second substrate portion 520 that can implement blade edge 620, increased hardness values obtained from a heat treatment process can be less than desirable for first substrate portion 510 that can implement blade body 630. By not subjecting bimetal substrate strip 500 to a heat treatment process, the respective hardness values of first substrate portion 510 and second substrate portion 520 can remain substantially constant while fabricating a bimetal razor blade (e.g., bimetal razor blade 600). As such, bimetal substrate strip 500 can be used to fabricate bimetal razor blades comprising both hard blade edges to facilitate blade edge quality and soft blade bodies to facilitate bent blade applications and/or contour fitting for shaving applications.

Another aspect of not subjecting bimetal substrate strip 500 to a heat treatment process can involve fabricating bimetal razor blades using bimetal substrate strip 500 with expanded surface treatment options. One such surface treatment option can involve pre-treating first substrate portion 510 for aesthetic purposes. For example, first substrate portion 510 can be cold rolled to impart specific textures or patterns on a surface of first substrate portion 510. As another example, a color of first substrate portion 510 can be modified by applying a polyester coating to first substrate portion 510.

FIG. 5 depicts bimetal substrate strip 500 as comprising one portion (e.g., second substrate portion 520) for forming a blade edge. FIG. 8 illustrates an example, non-limiting isometric view depicting a multi-metal substrate strip 800 comprising an additional portion (e.g., third substrate portion 830) for forming an additional blade edge when fabricating a double-edge, multi-metal razor blade. Multi-metal substrate strip 800 can have opposing longitudinal surfaces (e.g., longitudinal surfaces 802 and/or 804) that extend in a longitudinal direction 898 to define a thickness 803 of multi-metal substrate strip 800. In an embodiment, thickness 803 can substantially coincide with a corresponding thickness of a double-edge, multi-metal razor blade fabricated using multi-metal substrate strip 800. In an embodiment, first substrate portion 510, second substrate portion 520, and/or third substrate portion 830 can have a thickness 803 of less than 100 μm. In an embodiment, first substrate portion 510, second substrate portion 520, and/or third substrate portion 830 can have a thickness 803 of between 30 μm and 100 μm.

Multi-metal substrate strip 800 can also have a pair of lateral edges (e.g., lateral edges 806 and/or 808) opposing in a lateral direction 899. As shown by FIG. 8, lateral edge 806 can correspond with third substrate portion 830 of multi-metal substrate strip 800 and lateral edge 808 can correspond with second substrate portion 520 of multi-metal substrate strip 800. Third substrate portion 830 can comprise a third material. In an embodiment, the third material can have a third hardness that is distinct from the first hardness of the first material comprising first substrate portion 510. In an embodiment, the third material can have a third hardness that is distinct from the second hardness of the second material comprising second substrate portion 520. In this embodiment, first substrate portion 510, second substrate portion 520, and third substrate portion 830 can form a trimetal structure. In an embodiment, the third material can have a third hardness that is substantially similar to the second hardness of the second material comprising second substrate portion 520. In an embodiment, the third material and second material can be implemented by a common material. In this embodiment, first substrate portion 510, second substrate portion 520, and third substrate portion 830 can form a bimetal structure.

Third substrate portion 830 can further comprise a third width 837 extending in the lateral direction 899 from lateral edge 806. First substrate portion 510 can comprise a first width 817 extending in the lateral direction 899 from an interface 840 that can couple third substrate portion 830 to first substrate portion 510. Second substrate portion 520 can comprise a second width 827 extending in the lateral direction 899 from an interface 530 that can couple first substrate portion 510 to second substrate portion 520. Collectively, first width 817, second width 827, and third width 837 can define a width of multi-metal substrate strip 800. In an embodiment, first width 817 can be approximately less than 25 mm. In an embodiment, first width 817 can be approximately between 3 mm and 25 mm. In an embodiment, second width 827 and/or third width 837 can be approximately less than 500 μm. In an embodiment, second width 827 and/or third width 837 can be approximately between 100 μm and 500 μm. In an embodiment, second substrate portion 520 and/or third substrate portion 830 can be coupled to first substrate portion 510 via cladding, additive manufacturing, laser-assisted deposition, plasma-assisted deposition, thermal spray, or a combination thereof. In an embodiment, first substrate portion 510 and/or third substrate portion 830 can comprise copper, silver, or a combination thereof.

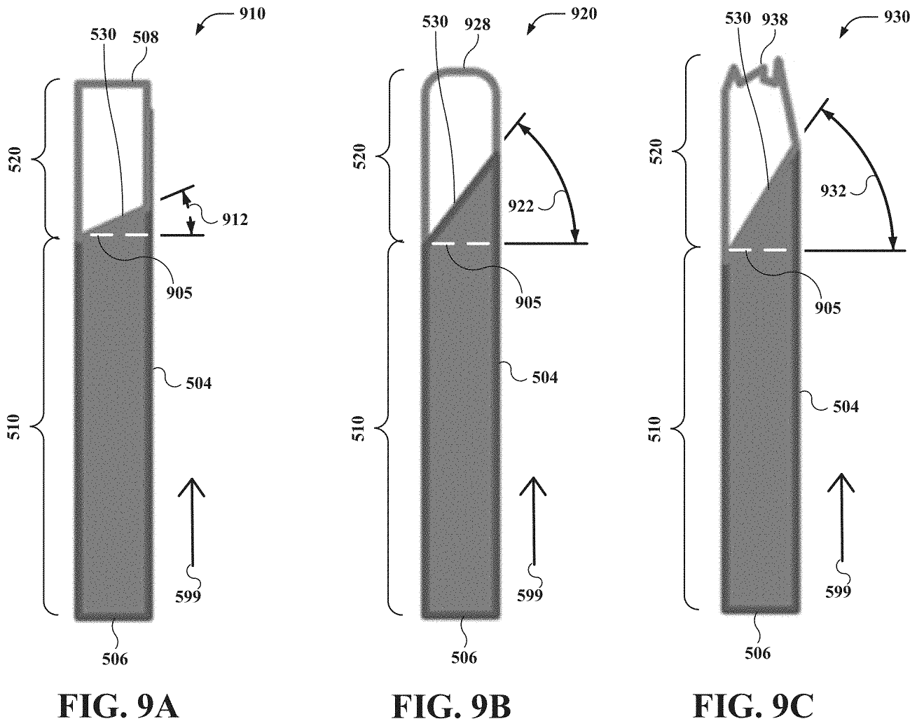

FIGS. 9A-9C illustrate example, non-limiting cross-sectional views of various lateral edge geometries and/or interface orientations of bimetal substrate strips, in accordance with one or more embodiments described herein. One aspect depicted by FIGS. 9A-9C is that the interface 530 that couples first substrate portion 510 to second substrate portion 520 can be non-orthogonal to longitudinal surface 504. For example, FIGS. 9A-9C depict a line 905 that is orthogonal to longitudinal surface 504. In FIGS. 9A-9C, interface 530 is depicted as being angled with respect to line 905. A comparison between FIGS. 9A-9C illustrates that interface 530 can assume different angular orientations with respect to line 905 in such non-orthogonal configurations. For example, an angle 922 formed between interface 530 and line 905 in FIG. 9B is greater than an angle 912 formed between interface 530 and line 905 in FIG. 9A. As another example, the angle 922 formed between interface 530 and line 905 in FIG. 9B is less than an angle 932 formed between interface 530 and line 905 in FIG. 9C. In an embodiment, varying an angular orientation between interface 530 and orthogonal to longitudinal surface 504 (e.g., line 905) can faciliate improving an adhesion between first substrate portion 510 and second substrate portion 520 facilitated by interface 530.

Another aspect depicted by FIGS. 9A-9C is that second substrate portion 520 can comprise lateral edges with different geometries prior to forming cutting-edge structure 610. For example, in FIGS. 5 and 9A, lateral edge 508 of second substrate portion 520 is depicted as being linear prior to formation of cutting-edge structure 610. As another example, second substrate portion 520 comprises lateral edges that are depicted as being non-linear prior to formation of cutting-edge structure 610. In FIG. 9B, second substrate portion 520 comprises a lateral edge 928 that is depicted as being rounded prior to formation of cutting-edge structure 610. In FIG. 9C, second substrate portion 520 comprises a lateral edge 938 that is depicted as being jagged or sharply uneven prior to formation of cutting-edge structure 610.

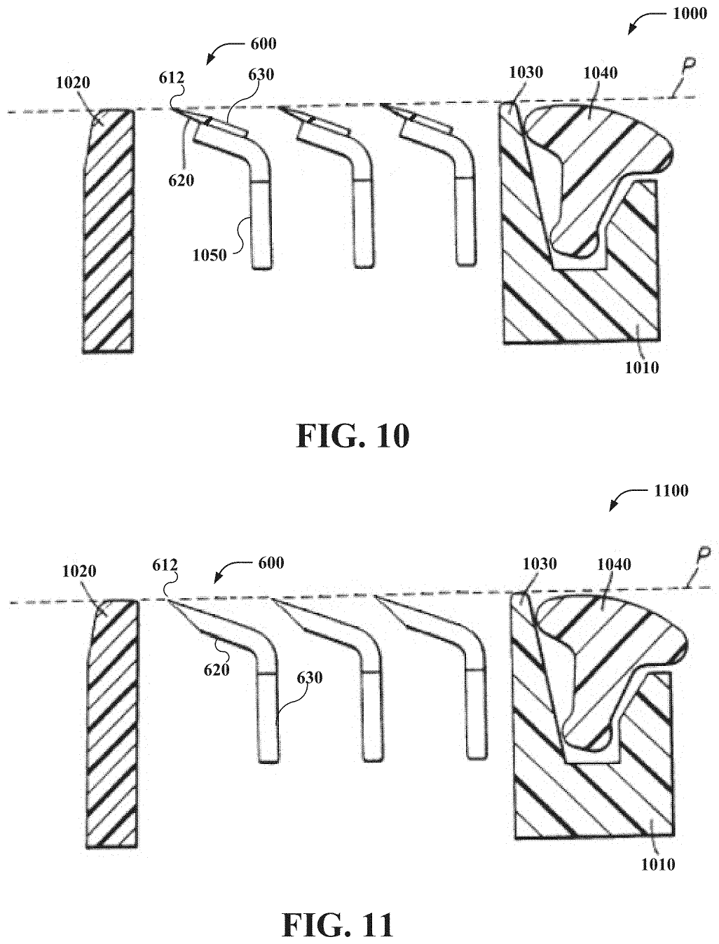

FIGS. 10-11 illustrate example, non-limiting cross-sectional views of razor blade units, in accordance with one or more embodiments described herein. Razor blade units 1000 and/or 1100 can be mounted on a razor handle. In an embodiment, razor blade units 1000 and/or 1100 can be permanently mounted to the razor handle (e.g., in a disposable razor). In an embodiment, razor blade units 1000 and/or 1100 can be implemented as a cartridge that can be releasably mounted to the razor handle. As shown by FIGS. 10-11, razor blade units 1000 and/or 1100 can comprise a frame 1010 that can define a guard 1020 and a cap 1030. Guard 1020 and/or cap 1030 can facilitate establishing a proper shaving geometry for razor blade units 1000 and/or 1100 during shaving applications. Cap 1030 can comprise a lubricating strip that can be mounted on frame 1010. One or more bimetal razor blades 600 can also be mounted on frame 1010 such that a corresponding blade tip 612 of the one or more bimetal razor blades 600 can be positioned within a common plane P. The common plane P can be tangential to respective skin engaging surfaces of guard 1020 and cap 1030 that can be brought into contact with a user for shaving applications. FIG. 10 depicts an embodiment in which the one or more bimetal razor blades 600 can be mounted on frame 1010 via blade supports 1050.

FIG. 11 depicts an embodiment in which the one or more bimetal razor blades 600 can be mounted on frame 1010 without blade supports 1050. In this embodiment, the one or more bimetal razor blades can be integrally formed using a bimetal substrate strip (e.g., bimetal substrate strip 500 of FIG. 5) that can be bent to form a bent portion 1110. In an embodiment, the bimetal substrate strip can be bent to form bent portion 1110 prior to sharpening blade edge 620 to form blade tip 612. In an embodiment, the bimetal substrate strip can be bent to form bent portion 1110 after sharpening blade edge 620 to form blade tip 612. In FIG. 11, bent portion 1110 is depicted as being formed in blade edge 620. In other embodiments, bent portion 1110 can be formed in blade body 630.

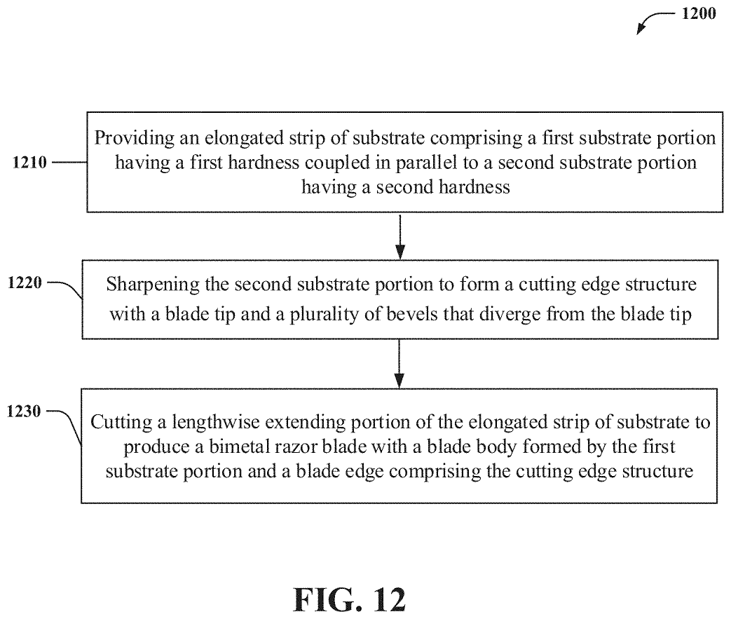

FIG. 12 illustrates a flow diagram of an example, non-limiting method 1200 of fabricating bimetal razor blades, in accordance with one or more embodiments described herein. One skilled in the art will appreciate that method 1200 describes a process that a human is generally incapable of accomplishing manually or by hand. In some embodiments, the method 1200 can be executed by a machine having one or more components that can be operatively coupled to a processor. Repetitive description of like elements employed in other embodiments described herein is omitted for sake of brevity. At 1210, the method 1200 can comprise providing an elongated strip of substrate comprising a first substrate portion coupled in parallel to a second substrate portion. The first substrate portion can comprise a first material with a first hardness and the second substrate portion can comprise a second material with a second hardness that is distinct from the first hardness. In an embodiment, the providing the elongated strip of substrate can comprise providing the elongated strip of substrate as a traverse wound coil. In an embodiment, the providing the elongated strip of substrate can comprise providing the elongated strip of substrate with a third substrate portion coupled to the first substrate portion and laterally opposing the second substrate portion. At 1220, the method 1200 can further comprise sharpening the second substrate portion to form a cutting-edge structure with a blade tip and a plurality of bevels that diverge from the blade tip. At 1230, the method 1200 can further comprise cutting a lengthwise extending portion of the substrate strip perpendicular to a longitudinal direction to singularize a bimetal razor blade with a blade body formed by the first substrate portion and a blade edge comprising the cutting-edge structure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor blade, comprising:
a blade body having a length and a width, the blade body formed of a first substrate portion comprising a first material having a first hardness; and
a blade edge extending along the length, the blade edge formed of a second substrate portion coupled to the first substrate portion, the second substrate portion comprising a second material having a second hardness that is distinct from the first hardness.

2. The razor blade of claim 1, wherein the first hardness is less than the second hardness.

3. The razor blade of claim 1, wherein the first hardness ranges from about 150 Vickers hardness to about 650 Vickers hardness.

4. The razor blade of claim 1, wherein the second hardness ranges from about 600 Vickers hardness to about 850 Vickers hardness.

5. The razor blade of claim 1, wherein the first substrate portion and the second substrate portion form a bimetal structure.

6. The razor blade of claim 1, wherein the first material comprises a first metal and the second material comprises a second metal that is distinct from the first metal.

7. The razor blade of claim 1, wherein the first material comprises stainless steel, a copper alloy, hygienic steel, colored steel, coated steel, or a combination thereof.

8. The razor blade of claim 1, wherein the first substrate portion comprises copper, silver, or a combination thereof.

9. The razor blade of claim 1, wherein the second material comprises hardened stainless steel, hardened tool steel, ceramic material, or a combination thereof.

10. The razor blade of claim 1, wherein the second substrate portion is coupled to the first substrate portion via an interface that is non-orthogonal to a surface of the blade body that extends between the length and the width.

11. The razor blade of claim 1, wherein the second substrate portion is coupled to the first substrate portion via cladding, additive manufacturing, laser-assisted deposition, plasma-assisted deposition, thermal spray, or a combination thereof.

12. The razor blade of claim 1, wherein the blade edge comprises a cutting-edge structure formed of the second substrate portion, and wherein the cutting-edge structure comprises a blade tip and a bevel that diverges from the blade tip.

13. The razor blade of claim 12, wherein a coating is disposed on the bevel.

14. The razor blade of claim 1, wherein a lateral edge of the second substrate portion forming the blade edge relative is non-linear prior to formation of a cutting-edge structure.

15. The razor blade of claim 1, wherein the first substrate portion or the second substrate portion have a thickness of less than 100 micrometers.

16. A razor blade, comprising:
a blade body having a length and a width, the blade body formed by a first substrate portion comprising a first material having a first hardness;
a first blade edge extending along the length, the first blade edge formed by a second substrate portion coupled to the first substrate portion, the second substrate portion comprising a second material having a second hardness that is distinct from the first hardness; and
a second blade edge extending along the length and laterally opposing the first blade edge, the second blade edge formed by a third substrate portion coupled to the first substrate portion.

17. The razor blade of claim 16, wherein the third substrate portion comprises a third material having a third hardness that is distinct from the first hardness.

18. The razor blade of claim 16, wherein the third substrate portion comprises a third material having a third hardness that is distinct from the second hardness.

19. The razor blade of claim 16, wherein the first substrate portion, the second substrate portion, and the third substrate portion form a bimetal structure.

20. A method of fabricating razor blades, comprising:
providing a substrate strip comprising a first substrate portion coupled in parallel to a second substrate portion, wherein the first substrate portion comprises a first material with a first hardness and the second substrate portion comprises a second material with a second hardness that is distinct from the first hardness;
sharpening the second substrate portion to form a cutting-edge structure with a blade tip and a plurality of bevels that diverge from the blade tip; and
cutting a lengthwise extending portion of the substrate strip perpendicular to a longitudinal direction to singularize a bimetal razor blade with a blade body formed by the first substrate portion and a blade edge comprising the cutting-edge structure.

21. The method of claim 20, wherein the providing the substrate strip comprises providing the substrate strip as a traverse wound coil.

22. The method of claim 20, wherein the providing the substrate strip comprises providing the substrate strip with a third substrate portion coupled to the first substrate portion and laterally opposing the second substrate portion.
